(19) United States
(12) Patent Application Publication
(10) Pub. No.: US 2023/0117307 A1
(43) Pub. Date: Apr. 20, 2023

(54) METHOD AND APPARATUS FOR META FEW-SHOT LEARNER

(71) Applicant: Samsung Electronics Co., Ltd., Suwon-si (KR)

(72) Inventors: Minyoung KIM, Staines (GB); Timothy HOSPEDALES, Staines (GB)

(21) Appl. No.: 17/843,590

(22) Filed: Jun. 17, 2022

(30) Foreign Application Priority Data
Oct. 15, 2021 (GB) 2114806.9
May 4, 2022 (GB) 2206509.8

(51) Int. Cl. G06V 10/776; G06V 10/82; G06V 10/70; G06V 10/774

(52) U.S. Cl. CPC G06V 10/776; G06V 10/82; G06V 10/87; G06V 10/774

(57) ABSTRACT

The subject-matter of the present disclosure relates to a computer-implemented method of training a machine learning, ML, meta learner classifier model to perform few-shot image or speech classification, the method comprising: training the machine learning, ML, meta learner classifier model by: iteratively obtaining a support set and a query set of a current episode; adapting the model using the support set; measuring a performance of the adapted model using the query set; and updating the classifier based on the performance; wherein adapting the model using the support set comprises: deriving a Laplace approximated posterior using a linear classifier based on Gaussian mixture fitting; and deriving a predictive distribution using the approximated posterior; wherein measuring the performance of the adapted model using the query set comprises: determining a loss associated with the predictive distribution using the query set; and wherein updating the classifier based on the performance comprises minimising the loss.

### CROSS REFERENCE TO RELATED APPLICATIONS

This application is based on and claims priority under 35 U.S.C. § 119(a) of a Great Britain patent application number 2114806.9, filed on Oct. 15, 2021, in the Great Britain Intellectual Property Office, and of a Great Britain patent application number 2206509.8, filed on May 4, 2022, in the Great Britain Intellectual Property Office, the disclosure of each of which is incorporated by reference herein in its entirety.

### BACKGROUND

### 1. Field

The present application generally relates to methods and apparatuses for a meta few-shot learner. In particular, the present application relates to a computer-implemented method for a meta few-shot learned via linear discriminant Laplace approximation.

### 2. Description of Related Art

Meta learning few-shot classification is an emerging problem in machine learning, ML, that received enormous attention recently, where the goal is to learn a model that can quickly adapt to a new task with only a few labelled data.

Few-shot/meta learning has received enormous attention recently with the surge of deep learning, and it now has a large body of literature. The approaches in few-shot learning can broadly fall into two folds: feature transfer and the other meta learning. The former uses the entire training data to pretrain the feature extractor network, which is then adapted to a new task by finetuning the network or training the output heads with the few-shot test data. On the other hand, the meta learning approaches follow the learning-to-learn paradigm, where the meta learner is trained by the empirical risk minimization principle.

In Bayesian meta learning, the prior on the underlying model parameters typically serves as the meta learner, and the adaptation to a new task corresponds to inference of the posterior predictive distribution. In this way the meta learning amounts to learning a good prior distribution from many training episodes. For the efficient meta training, the posterior predictive inference, i.e., adaptation procedure, needs to be fast and succinct (e.g., in closed forms). Some previous approaches used neural net approximation of the posterior predictive distribution (i.e., amortization), while others are based on gradient updates. The main focus of meta few-shot learning lies on how to learn the meaningful prior model that can be quickly and accurately adaptable to novel tasks with only a limited amount of evidence.

Therefore, the present applicant has recognised the need for an improved way to build a classifier quickly using limited data.

### SUMMARY

In a first approach of the present techniques, there is provided a computer-implemented method for training a machine learning, ML, model to perform few-shot image classification, the method comprising: obtaining support dataset and query dataset; and training a meta learner using the support dataset to output a classifier by: deriving a Laplace approximated posterior using the support dataset; deriving, using the posterior, a predictive distribution; and determining a loss associated with the predictive distribution using the query dataset, and training the meta learner to minimise the loss.

In another approach of the present techniques, there is provided a computer-implemented method of training a machine learning, ML, meta learner classifier model to perform few-shot image or speech classification, the method comprising: training the machine learning, ML, meta learner classifier model by: iteratively obtaining a support set and a query set of a current episode; adapting the model using the support set; measuring a performance of the adapted model using the query set; and updating the classifier based on the performance; wherein adapting the model using the support set comprises: deriving a Laplace approximated posterior using a linear classifier based on Gaussian mixture fitting; and deriving a predictive distribution using the approximated posterior; wherein measuring the performance of the adapted model using the query set comprises: determining a loss associated with the predictive distribution using the query set; and wherein updating the classifier based on the performance comprises minimising the loss.

Deriving a Laplace approximated posterior may comprise using a linear classifier based on Gaussian mixture fitting.

In a related approach, there is provided an apparatus for training a machine learning, ML, model to perform few-shot image classification, the apparatus comprising: at least one processor coupled to memory, and arranged to: obtain support dataset and query dataset; and train a meta learner using the support dataset to output a classifier by: deriving a Laplace approximated posterior using the support dataset; deriving, using the posterior, a predictive distribution; and determining a loss associated with the predictive distribution using the query dataset, and training the meta learner to minimise the loss.

In a further approach of the present techniques, there is provided a computer-implemented method for using a trained ML model to perform few-shot image classification, the method comprising: obtain task data, wherein the task data comprises a support dataset and query dataset; input the task data into a trained meta learner; output, from the trained meta learner, a class prediction for the query dataset.

In a further approach of the present techniques, there is provided a computer-implemented method of performing few-shot image or speech classification, the method comprising: obtaining a support set and a query set of an episode; and predicting a class of the query set using the machine learning, ML, meta learner classifier model trained according to the method described above.

In a related approach, there is provided an apparatus for using a trained ML model to perform few-shot image classification, the apparatus comprising: at least one processor coupled to memory, arranged to: obtain task data, wherein the task data comprises a support dataset and query dataset; input the task data into a trained meta learner; output, from the trained meta learner, a class prediction for the query dataset.

In a related approach of the present techniques, there is provided a non-transitory data carrier carrying processor control code to implement the methods described herein.

As will be appreciated by one skilled in the art, the present techniques may be embodied as a system, method or computer program product. Accordingly, present techniques may take the form of an entirely hardware embodiment, an entirely software embodiment, or an embodiment combining software and hardware aspects.

Furthermore, the present techniques may take the form of a computer program product embodied in a computer readable medium having computer readable program code embodied thereon. The computer readable medium may be a computer readable signal medium or a computer readable storage medium. A computer readable medium may be, for example, but is not limited to, an electronic, magnetic, optical, electromagnetic, infrared, or semiconductor system, apparatus, or device, or any suitable combination of the foregoing.

Computer program code for carrying out operations of the present techniques may be written in any combination of one or more programming languages, including object oriented programming languages and conventional procedural programming languages. Code components may be embodied as procedures, methods or the like, and may comprise sub-components which may take the form of instructions or sequences of instructions at any of the levels of abstraction, from the direct machine instructions of a native instruction set to high-level compiled or interpreted language constructs.

Embodiments of the present techniques also provide a non-transitory data carrier carrying code which, when implemented on a processor, causes the processor to carry out any of the methods described herein.

The techniques further provide processor control code to implement the above-described methods, for example on a general purpose computer system or on a digital signal processor (DSP). The techniques also provide a carrier carrying processor control code to, when running, implement any of the above methods, in particular on a non-transitory data carrier. The code may be provided on a carrier such as a disk, a microprocessor, CD- or DVD-ROM, programmed memory such as non-volatile memory (e.g. Flash) or read-only memory (firmware), or on a data carrier such as an optical or electrical signal carrier. Code (and/or data) to implement embodiments of the techniques described herein may comprise source, object or executable code in a conventional programming language (interpreted or compiled) such as Python, C, or assembly code, code for setting up or controlling an ASIC (Application Specific Integrated Circuit) or FPGA (Field Programmable Gate Array), or code for a hardware description language such as Verilog (RTM) or VHDL (Very high speed integrated circuit Hardware Description Language). As the skilled person will appreciate, such code and/or data may be distributed between a plurality of coupled components in communication with one another. The techniques may comprise a controller which includes a microprocessor, working memory and program memory coupled to one or more of the components of the system.

It will also be clear to one of skill in the art that all or part of a logical method according to embodiments of the present techniques may suitably be embodied in a logic apparatus comprising logic elements to perform the steps of the above-described methods, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

In an embodiment, the present techniques may be realised in the form of a data carrier having functional data thereon, said functional data comprising functional computer data structures to, when loaded into a computer system or network and operated upon thereby, enable said computer system to perform all the steps of the above-described method.

The methods described above may be wholly or partly performed on an apparatus, i.e. an electronic device, using a machine learning or artificial intelligence model. The model may be processed by an artificial intelligence-dedicated processor designed in a hardware structure specified for artificial intelligence model processing. The artificial intelligence model may be obtained by training. Here, “obtained by training” means that a predefined operation rule or artificial intelligence model configured to perform a desired feature (or purpose) is obtained by training a basic artificial intelligence model with multiple pieces of training data by a training algorithm. The artificial intelligence model may include a plurality of neural network layers. Each of the plurality of neural network layers includes a plurality of weight values and performs neural network computation by computation between a result of computation by a previous layer and the plurality of weight values.

As mentioned above, the present techniques may be implemented using an AI model. A function associated with AI may be performed through the non-volatile memory, the volatile memory, and the processor. The processor may include one or a plurality of processors. At this time, one or a plurality of processors may be a general purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The one or a plurality of processors control the processing of the input data in accordance with a predefined operating rule or artificial intelligence (AI) model stored in the non-volatile memory and the volatile memory. The predefined operating rule or artificial intelligence model is provided through training or learning. Here, being provided through learning means that, by applying a learning algorithm to a plurality of learning data, a predefined operating rule or AI model of a desired characteristic is made. The learning may be performed in a device itself in which AI according to an embodiment is performed, and/or may be implemented through a separate server/system.

The AI model may consist of a plurality of neural network layers. Each layer has a plurality of weight values, and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning algorithm is a method for training a predetermined target device (for example, a robot) using a plurality of learning data to cause, allow, or control the target device to make a determination or prediction. Examples of learning algorithms include, but are not limited to, supervised learning, unsupervised learning, semi-supervised learning, or reinforcement learning.

### BRIEF DESCRIPTION OF THE DRAWINGS

Implementations of the present techniques will now be described, by way of example only, with reference to the accompanying drawings, in which:

FIG. 1 is a schematic diagram a problem to be solved;

FIG. 2 is a schematic diagram illustrating meta (few-shot) learning;

FIG. 3 illustrates Bayesian GP meta learning;

FIG. 4 illustrates Laplace approximation;

FIG. 5 illustrates the linear discriminant analysis, LDA, plugin of the present techniques;

FIG. 6 is a flowchart of example steps for training a machine learning, ML, model using the present techniques;

FIG. 7 is a flowchart of example steps to test the ML model; and

FIG. 8 shows an algorithm for training and test.

### DETAILED DESCRIPTION

Broadly speaking, the present techniques generally relate to methods and apparatuses for a meta few-shot learner. In particular, the present application relates to a computer-implemented method for a meta few-shot learned via linear discriminant Laplace approximation.

Advantageously, the present techniques may provide a machine learning, ML, model that can classify new fine categories on-the-fly without extra training steps. For example, if a trained ML model can already identify broad categories, such as crockery or mugs, the present techniques may enable the trained ML model to identify a new category, such as “my mug” (where the model may be provided with an image of my mug), without retraining. In another example, the present techniques may enable a trained ML model to perform personalised speech adaptation for a new user, based on the fact it has been trained to recognise the speech of other users already.

Few-shot classification is the task of predicting class labels of data instances that have novel unseen class semantics, potentially from a novel domain, where the learner is given only a few labelled data from the domain. It receives significant attention recently in machine learning, ML, not only due to the practical reason that annotating a large amount of data for training deep models is prohibitively expensive, but also the constant endeavour in artificial intelligence, AI, to build human-like intelligence where the human is extremely good at recognizing new categories from a few examples.

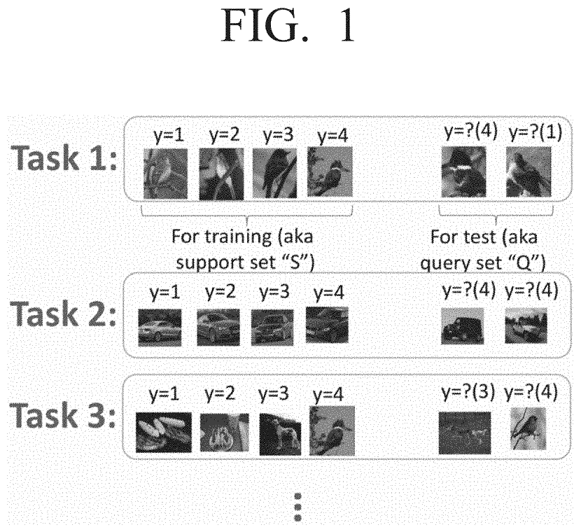

FIG. 1 is a schematic diagram a problem to be solved. In machine learning, ML, there may be many different labelled tasks but only a few samples for each task, as shown in the diagram. The goals of meta (few-shot) learning include: building a classifier for a new task quickly; avoiding training a model from scratch on the fly because this is slow and there are only a few samples in the dataset S; and learning “how to learn” from many different tasks.

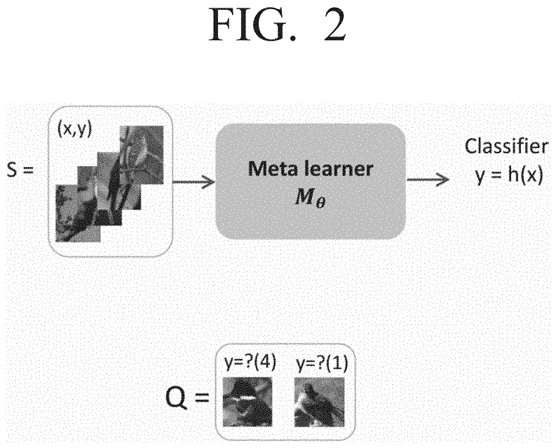

FIG. 2 is a schematic diagram illustrating meta (few-shot) learning. The idea, as illustrated in the Figure, is to train a meta learner (M) that takes the support dataset (S) as an input and returns a classifier as an output. (In other words, the meta learner can be thought of as a neural network that takes a dataset (S) as input and returns a classifier as output). The meta learner (with parameters θ) is trained to minimise the loss on the query dataset (Q). The loss for is M_{θ} on Q=Cross-Ent(y∥ŷ=h(x)).

In order to build a model that can generalize well to a novel task with only a few samples, meta learning forms a training stage that is similar to the test scenario. More specifically, during the training stage, the learner sees many tasks (or episodes) where each task consists of the support and query sets: the learner adapts the model to the current task using a few labelled data in the support set, and the performance of the adapted model is measured on the query set, which is used as a learning signal to update the learner. This is in nature a learning-to-learn paradigm, and it often leads to more promising results in certain scenarios than simple supervised feature (transfer) learning. Although recently there were strong baselines introduced for the latter with some feature transformations, in this document the focus is on the meta learning paradigm.

As meta few-shot learning essentially aims to generalize well from only a few observations about a new task domain, it is important to learn prior information that is shared across different tasks. In this sense, the Bayesian approach is attractive in that the prior belief can be expressed effectively, and the belief can be easily adapted to a new task based on the given evidence, in a principled manner In Bayesian meta learning, the adaptation to a new task corresponds to posterior predictive distribution inference, and meta learning amounts to learning a good prior distribution from many training episodes.

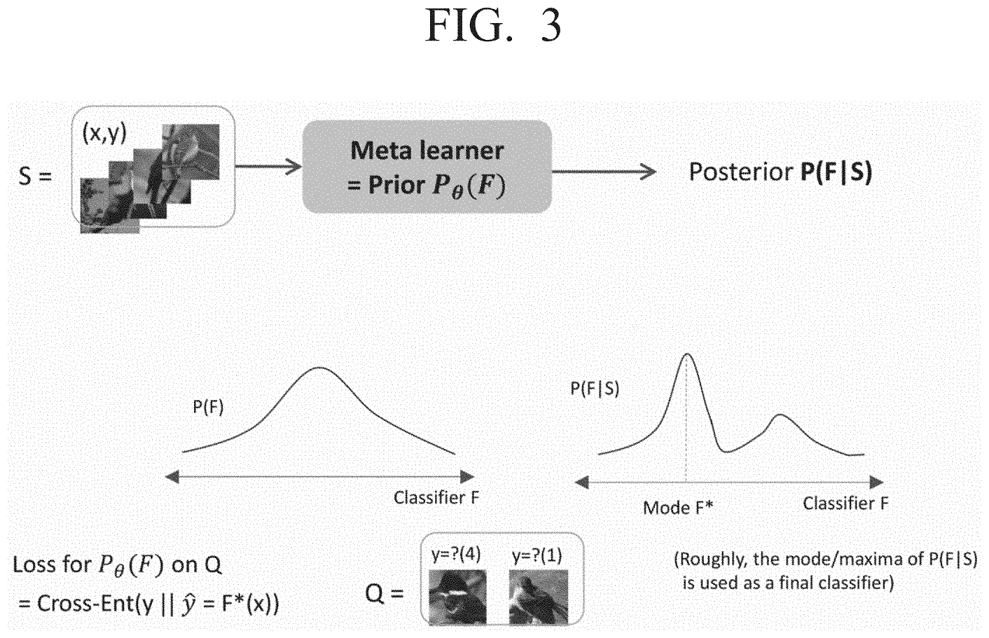

FIG. 3 illustrates Gaussian process (GP) meta learning. GP is a sort of Bayesian model. The idea of Gaussian process meta learning is as follows:

Define M_{θ} as a prior distribution P(F) over classifiers F(x). (Learning meta learner=choosing p(F));

Output of meta learner is a posterior distribution, P(F|S)∝P(F)×P(S|F)

Note, F=(w,b) elsewhere in this document.

However, there are issues with GP meta learning. One issue is that computing the posterior P(F|S)∝P(F)×P(S|F) is often very difficult and time consuming Another issue is that P(F|S) is often hard to deal with (i.e. P(F|S) is a very complex distribution, non-Gaussian, etc.).

To enable efficient Bayesian meta learning, the posterior predictive inference needs to be fast and succinct (e.g., closed form). To this end, the present techniques consider the Gaussian process (GP) model with the linear deep kernel that allows parametric treatment of GP via the weight-space view. A recent similar attempt resorted to regression-based likelihood model for the classification problem to derive closed-form inference, and such an ad hoc strategy can potentially lead to performance degradation. Instead, the present techniques propose a novel Laplace approximation for the GP posterior with a linear discriminant plugin, which avoids iterative gradient steps to find the maximum-a-posterior (MAP) adaptation solution, and allows a closed-form predictive distribution that can be used in stochastic gradient meta training efficiently. Hence, it is computationally more attractive than gradient-based adaptation approaches by construction, and more amenable to train than neural net approximations of the predictive distribution (i.e., amortization).

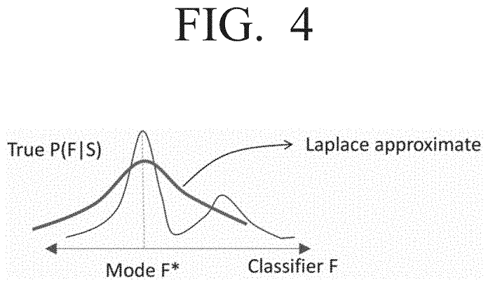

FIG. 4 illustrates Laplace approximation, LA. Laplace approximation is a method to approximate a difficult posterior. The idea of LA is to approximate P(F|S) by the Gaussian centered at the mode. But still the remaining issue is that finding the mode F*of P(F|S) is time consuming (requires gradient-based optimization), which makes it inappropriate for real systems. Thus, one motivation behind the present techniques is how to (approximately) find the mode quickly (without performing gradient-based optimization), and accurately.

In the following, the improved performance of the GP approach over the regression-based previous work and other state-of-the-arts on several benchmark datasets is shown, in both within- and cross-domain few-shot learning problems.

Meta few-shot learning framework. The (C-way, k-shot) episodic meta few-shot classification problem can be formally defined as follows:

Training stage (repeated for T times/episodes):

Sample training data (S,Q) for this episode: support set S={(x,y)} and query set Q={(x,y)}, where S consists of C k samples (k samples for each of the C classes), and Q contains C k_{q} samples (k_{q} samples per class). We denote by y ϵ {1, . . . , C} the class labels in (S,Q), however, the semantic meaning of the classes is different from episode to episode.

With (S,Q), we train a meta learner [symbol] (S)→h where the output of [symbol] is a C-way classifier, h: [symbol] {1, . . . , C}. The training objective is typically defined on the query set, e.g., the prediction error of h on Q.

Test Stage:

The k/k_{q}-shot test data (S*, Q*) are sampled, but the query set Q*is not revealed. For the k-shot support set S*={(x,y)}, we apply our learned [symbol] to S*to obtain the classifier h*= [symbol] (S*). Again, the semantic meaning of the test class labels are different from those in the training stage. The performance of h*is measured on the test query set Q*.

For instance, in the popular ProtoNet (Jake Snell, Kevin Swersky, and Richard S. Zemel. Prototypical networks for few-shot learning. CoRR, abs/1703.05175, 2017) the meta learner learns the parameters θ of the feature extractor ϕ_{θ}(x) (e.g., convolutional networks), and the meta learner's output h= [symbol] S) is the nearest centroid classifer where the centroids are the class-wise means in S in the feature space. Note that h(x) admits a closed form (softmax), and the meta training updates 9 by stochastic gradient descent with the loss, [symbol] _{(xy)˜Q}[CrossEnt(y, h(x))]. Another example is the GP meta learning framework that essentially considers h= [symbol] (S) as a GP posterior predictive model, that is,

p(y|x,S)=∫p(y|f(x))p(f|S)df Equation 1

where f is a GP function, h(x) is defined as a probabilistic classifier p(y|x,S), and p (f|S)∝p(f)·Π_{(x,y)∈S}p(y|f(x)). Meta training of [symbol] amounts to learning the GP prior distribution p(f) (i.e., GP mean/covariance functions). The recent GPDKT [Massimiliano Patacchiola, Jack Turner, Elliot J. Crowley, and Amos Storkey. Bayesian meta-learning for the fewshot setting via deep kernels. In Advances in Neural Information Processing Systems, 2020.] is one incarnation of this GP framework.

Brief review of GPDKT. GPDKT assumes the GP regression model (its usage to classification will be described shortly)

f(·)˜ [symbol] (0,k_{θ}(·,·)) Equation 2

y=f(x)+ϵ,ϵ˜ [symbol] (0,σ²) Equation 3

where the GP covariance function k_{θ} is defined as the deep kernel:

k_{θ}(x,x′)=\tilde{k}(ϕ_{θ}(x),ϕ_{θ}(x′)), Equation 4

where k_{θ} (x) is the feature extractor (comparable to that in ProtoNet) and \tilde{k}(·,·) is a conventional kernel function (e.g., Gaussian RBF, linear, or cosine similarity). We abuse the notation to denote by θ all the parameters of the deep kernel, including those from the outer kernel \tilde{k}. They pose the meta training as the marginal likelihood maximization on both support and query sets:

$${max}_{θ} \int p ( f ) \cdot {\prod }_{( x , y ) ∈ S ⋃ Q} p ( y \vert f ( x ) ) df \qquad Equation 5$$

Due to the regression model, the marginal likelihood admits a closed form, and one can easily optimize (5) by stochastic gradient ascent. To extend the GP model to the classification problem, instead of adopting a softmax-type likelihood p (y|f (x)), they rather stick to the GP regression model. This is mainly for the closed-form posterior and marginal data likelihood. In the binary classification problem, they assign real-valued y=±1.0 as target response values for positive/negative classes, respectively, during training. At the test time, they threshold the real-valued outputs to get the discrete class labels. For the multi-class C-way problem with C>2, they turn it into C binary classification problems by one-vs-rest conversion. Then during training, they maximize the sum of the marginal log-likelihood scores over the C binary problems, while at test time the one with the largest predictive mean [symbol] [y|x,S] over the C problems is taken as the predicted class. Although this workaround allows fast adaptation and training with the closed-form solutions from GP regression, the ad hoc treatment of the discrete class labels may degrade the prediction accuracy.

The approach of the present techniques. The present techniques consider the Bayesian Gaussian process (GP) approach, in which the GP is meta-learned prior, and the adaptation to a new task is carried out by the GP predictive model from the posterior inference. The present techniques adopt the Laplace posterior approximation, but to circumvent the iterative gradient steps for finding the MAP solution, a novel linear discriminant analysis (LDA) plugin is introduced as a surrogate for the MAP solution. In essence, the MAP solution is approximated by the LDA estimate, but to take the GP prior into account, the prior-norm adjustment is adopted to estimate LDA's shared variance parameters, which ensures that the adjusted estimate is consistent with the GP prior. This enables closed-form differentiable GP posteriors and predictive distributions, thus allowing fast meta training. Considerable improvement over the previous approaches is demonstrated below.

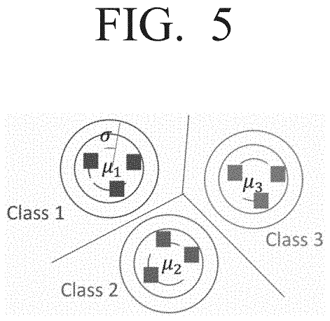

FIG. 5 illustrates the linear discriminant analysis, LDA, plugin of the present techniques. Linear Discriminant Analysis is a linear classifier p(x,y) based on Gaussian mixture fitting, that can be estimated quickly by a closed form (Equation (14) below). The idea is as follows. First, perform LDA on Support (S) to have P(x,y). Then induce P(y|x) from LDA's P(x,y) by Bayes rule. Then, match P(y|x) and GP's P(y|F(x)). This leads to the LDA-induced mode F*(very quick using Equation (17) below). However, there are two issues. Firstly, LDA's standard deviation (σ) estimation is unreliable (due to a small number of samples). Secondly, the prior P(F) is not taken into account in the LDA estimate.

To solve these two issues, the present techniques provide a prior-norm adjusted LDA plugin. The prior P(F) of the present techniques imposes special constraints on F. Specifically, Norm∥F∥ is (approximately) proportional to the standard deviation of P(F). (Equation (18) below). Using the constraints, LDA's σ estimation can be corrected (prior-norm adjusted), as shown by Equation (19) below. This deals with the first issue mentioned above. This also yields a sensible estimate of the mode F*of P(F|S) (Equations (19) and (20)). In this way, the mode estimation takes into account the prior P(F), thereby dealing with the second issue mentioned above. The approach provided by the present techniques is called GP-LD-LA (or GPLDLA), i.e. GP linear discriminant Laplace approximation.

In this section, the Laplace approximation GP posterior formulation is described for the task adaptation, where the novel linear discriminant plug-in is introduced to circumvent the iterative optimization for the MAP solution and enable the closed-form formulas. The formalism admits the softmax classification likelihood model, more sensible than the regression-based treatment of the classification problem.

The present techniques adopt the weight-space view of the Gaussian process model using the linear-type deep kernel, and consider the softmax likelihood model with C functions F (x)={fⱼ(x)}ⱼ₌₁^{C}:

$$p ( y \vert F ( x ) ) = \frac{{e}^{{f}_{y} ( x )}}{{\sum }_{j = 1}^{C} {e}^{{f}_{j} ( x )}} , {f}_{j} ( x ) = {w}_{j}^{⊤} ϕ ( x ) + {b}_{j} \qquad Equation 6$$

$${w}_{j} ∼ 𝒩 ( 0 , {β}^{2} I ) , {b}_{j} ∼ 𝒩 ( 0 , {β}_{b}^{2} ) for j = 1 … C \qquad Equation 7$$

Let W=[w₁, . . . , w_{C}] and B=[b₁, . . . , b_{C}] be the weight-space random variables for the GP functions. Note that in (7) the prior (scalar) parameters β,β_{b} are shared over all C functions, which is reasonable considering that the semantic meaning of classes changes from episode to episode. And it is easy to see that the i.i.d. priors on (wⱼ, bⱼ) makes {fⱼ(·)}ⱼ₌₁^{C} GPs with a zero mean and the covariance function,

Cov(fⱼ(x),fⱼ(x′))=β²ϕ(x)^{T}ϕ(x′)+β_{b}² Equation 8

This can be interpreted as adopting a linear outer kernel \tilde{k}(z, z′)=z^{T}z′ in the deep kernel (4) with some scaling and biasing. Although our formulation excludes more complex nonlinear outer kernels (e.g., RBF or polynomial), it has been shown by others that the linear or cosine-similarity outer kernel empirically performed the best among other choices. Note that the latter cosine-similarity kernel is obtained by unit-norm feature transformation

$$( ϕ ( x ) \to \frac{ϕ ( x )}{‖ ϕ ( x ) ‖} ) .$$

Given the support set S={(x,y)}, the GP posterior distribution of fⱼ (x) at some arbitrary input x becomes p(fⱼ(x)|S)=p(wⱼ^{T}ϕ(x)+bⱼ|S), and this is determined by the posterior p (W,B|S), where (up to constant)

$$log p ( W , B \vert S ) = - {\sum }_{j = 1}^{C} ( \frac{{‖ {w}_{j} ‖}^{2}}{2 {β}^{2}} + \frac{{b}_{j}^{2}}{2 {β}_{b}^{2}} ) + {\sum }_{( x , y ) ∈ S} ( {w}_{y}^{⊤} ϕ ( x ) + {b}_{y} - log {\sum }_{j = 1}^{C} {e}^{{w}_{j}^{⊤} ϕ ( x ) + {b}_{j}} ) \qquad Equation 9$$

The posterior p(W,B|S) is used to build the task(S)-adapted classifier p (y|x,S), the GP predictive distribution derived from (1). And the meta training in our model amounts to optimizing the classification (cross-entropy) loss of the adapted classifier on the query set with respect to the GP prior parameters (i.e., β,β_{b}, and the parameters θ of the feature extractor network ϕ, averaged over all training episodes. That is, our meta training loss/optimization can be written as:

$${min}_{θ , β , {β}_{b}} {𝔼}_{( S , Q )} [ - {\sum }_{( x , y ) ∈ Q} log p ( y \vert x , S ) ] \qquad Equation 10$$

$$where p ( y \vert x , S ) = \int \int p ( W , B \vert S ) p ( y \vert x , W , B ) dWdB ,$$

and the expectation is taken over (S,Q) samples from training episodes/tasks.

Considering the dependency of the loss on these prior parameters as per (10), it is crucial to have a succinct (e.g., closed-form) expression for p(W,B|S), as well as the predictive distribution p (y|x,S). However, since p (W,B|S) does not admit a closed form due to the non-closed-form normalizer (i.e., the log-sum-exp of (9) over {wⱼ, bⱼ}ⱼ), we adopt the Laplace approximation that essentially approximates (9) by the second-order Taylor at around the MAP estimate {w*ⱼ, b*ⱼ}ⱼ, i.e., the maximum of (9).

Laplace approximation via LDA plugin with prior-norm adjustment. Specifically we follow the diagonal covariance Laplace approximation with diagonalized Hessian of (9), which leads to the factorized posterior p(W,B|S)=Πⱼ₌₁^{C}p(wⱼ,bⱼ|S). The approximate posterior can be derived as p(wⱼ,bⱼ|S)≈ [symbol] (wⱼ; w*ⱼ, V*ⱼ) [symbol] (bⱼ; b*ⱼ, v*ⱼ), with

$$\begin{matrix}{V}_{j}^{*} = {Diag ( \frac{1}{{β}^{2}} + {\sum }_{( x , y ) ∈ S} {a}^{*} ( x , y , j ) {ϕ ( x )}^{2} )}^{- 1} & \end{matrix} \qquad Equation 11$$

$${v}_{j}^{*} = {( \frac{1}{{β}_{b}^{2}} + {\sum }_{( x , y ) ∈ S} {a}^{*} ( x , y , j ) )}^{- 1} \qquad Equation 12$$

$$where {a}^{*} ( x , y , j ) = p ( y = j \vert {F}^{*} ( x ) ) - {p ( y = j \vert {F}^{*} ( x ) )}^{2} , {F}^{*} ( x ) = {\{ {f}_{j}^{*} ( x ) \}}_{j} with {f}_{j}^{*} ( x ) = {w}_{j}^{* ⊤} ϕ ( x ) + {b}_{j}^{*} ,$$

and all operations are element-wise.

However, obtaining the MAP estimate {w*ⱼ, b*ⱼ}ⱼ, i.e., the maximum of (9), although the objective is concave, usually requires several steps of gradient ascent, which can hinder efficient meta training. Recall that our meta training amounts to minimizing the loss of the task-adapted classifier p (y|x,S) on a query set with respect to the feature extractor ϕ_{θ} (·) and the GP prior parameters β,β_{b}, and we prefer to have succinct (closed-form-like) expression for p (y|x,S) in terms of θ, β,β_{b}. The iterative dependency of p (y|x,S) on ϕ, β,β_{b}, resulting in a similar strategy as MAML (Chelsea Finn, Pieter Abbeel, and Sergey Levine. Model agnostic meta-learning for fast adaptation of deep networks. In International Conference on Machine Learning, 2017), would make the meta training computationally expensive. To this end, we propose a novel linear discriminant analysis (LDA) plugin technique as a surrogate of the MAP estimate.

LDA-Plugin. We preform the LDA on the support set S, which is equivalent to fit a mixture of Gaussians with equi-covariances by maximum likelihood. More specifically, we consider the Gaussian mixture model (with some abuse of notation, e.g., p(x) instead of p (ϕ(x))),

p(x,y)=p(y)p(x|y)=π_{y} [symbol] (ϕ(x);μ_{y},σ²I) Equation 13

where we assume the shared spherical covariance matrix across different classes. The maximum likelihood (ML) estimate on S can be derived as:

$${π}_{j}^{*} = \frac{{n}_{j}}{n} , {μ}_{j}^{*} = {\sum }_{x ∈ {S}_{j}} \frac{ϕ ( x )}{{n}_{j}} , {σ}^{{2}^{*}} = {\sum }_{j = 1}^{C} {\sum }_{x ∈ {S}_{j}} \frac{{‖ ϕ ( x ) - {μ}_{j}^{*} ‖}^{2}}{nd} \qquad Equation 14$$

$$where {S}_{j} = \{ ( x , y ) ∈ S : y = j \} , {n}_{j} = \vert {S}_{j} \vert , n = \vert S \vert , and d = dim ( ϕ ( x ) ) .$$

Then our idea is to use this ML-estimated Gaussian mixture to induce the class predictive model p(y|x)=p(x,y)/p(x), and match it with our GP likelihood p (y|F(x)) in (6) to obtain {wⱼ, bⱼ}ⱼ, which serves as a surrogate of the MAP estimate {w*ⱼ, b*ⱼ}ⱼ. More specifically, the class predictive from the Gaussian mixture is:

$$p ( y \vert x ) = \frac{{π}_{y} 𝒩 ( ϕ ( x ) ; {μ}_{y} , {σ}^{2} I )}{{\sum }_{j} {π}_{j} 𝒩 ( ϕ ( x ) ; {μ}_{j} , {σ}^{2} I} = \frac{exp ( {( {μ}_{y} / {σ}^{2} )}^{⊤} ϕ ( x ) + log {π}_{y} - {‖ {μ}_{y} ‖}^{2} / ( 2 {σ}^{2} ) )}{{\sum }_{j} exp ( {( {μ}_{j} / {σ}^{2} )}^{⊤} ϕ ( x ) + log {π}_{j} - {‖ {μ}_{j} ‖}^{2} / ( 2 {σ}^{2} ) )} \qquad Equation 15$$

We match it with the GP likelihood model p (y|F(x)) from (6), that is,

$$p ( y \vert F ( x ) ) = \frac{exp ( {w}_{y}^{⊤} ϕ ( x ) + {b}_{y} )}{{\sum }_{j} exp ( {w}_{j}^{⊤} ϕ ( x ) + {b}_{j} )} \qquad Equation 16$$

which establishes the following correspondence:

$${w}_{j} = \frac{{μ}_{j}}{{σ}^{2}} , {b}_{j} = log {π}_{j} - \frac{{‖ {μ}_{j} ‖}^{2}}{2 {σ}^{2}} + α \qquad Equation 17$$

where α is a constant (to be estimated).

We aim to plug the LDA estimates (14) in (17), to obtain the MAP surrogate. However, there are two issues in this strategy: First, the ML estimate σ^{2*}can raise a numerical issue in the few-shot learning since the number of samples is too small (in the one-shot case (nⱼ=1), e.g., degenerate σ^{2*}=0), although π*and μ*incur no such issue. Secondly, it is only the ML estimate with data S, and we have not taken into account the prior on {wⱼ, bⱼ}ⱼ. To address both issues simultaneously, we propose a prior-norm adjustment strategy, which also leads to a sensible estimate for σ².

Prior-norm adjustment. We will find σ² that makes the surrogate wⱼ in (17) become consistent with our prior p (wⱼ)= [symbol] (0, β²I). Since wⱼ sampled from the prior can be written as wⱼ=[βϵⱼ₁, . . . , βϵ_{jd}]^{T} with ϵⱼ₁, . . . ϵ_{jd}˜ [symbol] (0,1), we have:

$${‖ {w}_{j} ‖}^{2} = {β}^{2} {\sum }_{l = 1}^{d} {ϵ}_{jl}^{2} = {β}^{2} d \cdot \frac{1}{d} {\sum }_{l = 1}^{d} {ϵ}_{jl}^{2} \approx {β}^{2} d \cdot 𝔼 [ {ϵ}_{jl}^{2} ] = {β}^{2} d \qquad Equation 18$$

where the approximation to the expectation gets more accurate as d increases due to the law of large numbers.

Equation (18) implies that any wⱼ that conforms to the prior has the norm approximately equal to β\sqrt{d}. Hence we enforce this to the surrogate wⱼ in (17) to determine σ². To consider all j=1 . . . C, we establish a simple mean-square equation, (1/C) Σⱼ₌₁^{C}∥μ*ⱼ/σ²∥²=β²d, and the solution leads to the prior-norm adjusted MAP surrogate (denoted by wⱼ) as follows:

$${σ}^{{2}^{*}} = \frac{1}{β \sqrt{d}} \sqrt{\frac{1}{C} {\sum }_{j = 1}^{C} ‖ {μ}_{j}^{*} {‖}^{2} ,} {w}_{j}^{*} = \frac{{μ}_{j}^{*}}{{σ}^{{2}^{*}}} \qquad Equation 19$$

Determining α. We adjust bⱼ to take into account its prior, and from (17) this amounts to finding a properly. We directly optimize the log-posterior (9) with respect to α. Denoting \hat{b}ⱼ=log π*ⱼ−−∥μ*ⱼ∥²/(2σ^{2*})(i.e., bⱼ=\hat{b}ⱼ+α), we solve

$$\frac{\partial log p ( {\{ {b}_{j} \}}_{j} \vert S )}{\partial α} = - {\sum }_{j = 1}^{C} \frac{{\hat{b}}_{j} + α}{{β}_{b}^{2}} = 0 ,$$

and have a MAP surrogate (denoted by b*ⱼ) as:

$${α}^{*} = - \frac{1}{C} {\sum }_{j = 1}^{C} {\hat{b}}_{j} , {b}_{j}^{*} = {\hat{b}}_{j} - {α}^{*} \qquad Equation 20$$

Empirical verification. To see the quality of our prior-norm adjusted LDA estimate as an approximation to the MAP, we compute the divergence between the predictive distributions KL(p₀(y|x,S)∥p₁(y|x,S)), where p₀ (y|x,S) is from the original Laplace approximation that uses the MAP, and p₁(y|x,S) from our prior-norm adjusted LDA estimate. On CUB and miniImageNet datasets, we test different values of, β_{b}Å{10⁻³, 10⁻², 10⁻¹, 1}, each averaged over 100 random runs. The largest KL divergences out of these 16 parameter combinations are: 0.0353/0.0538 on CUB and 0.0562/0.0260 on miniImageNet for 1-shot/5-shot. The small divergences imply that the proposed strategy approximates well the original Laplace approximation in predictive distributions.

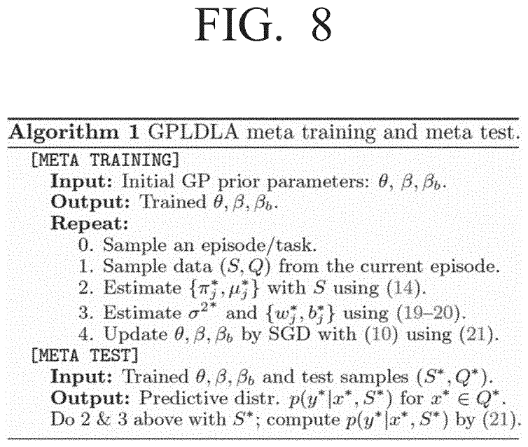

Summary We have derived the Laplace approximated posterior p(wⱼ,bⱼ|S) in (11-12) with the MAP surrogate (w*ⱼ, hi) from (19) and (20). From this GP posterior, we derive the predictive distribution p (y|x,S) that is used in our meta training (10) as well as meta test. We adopt the Monte Carlo estimate with M (reparametrized) samples from the posterior:

$$p ( y \vert x , S ) \approx \frac{1}{M} {\sum }_{m = 1}^{M} p ( y \vert x , {W}^{( m )} , {B}^{( m )} ) \qquad Equation 21$$

$$where {w}_{j}^{( m )} = {w}_{j}^{*} + {V}_{j}^{* \frac{1}{2}} {ϵ}_{j}^{( m )} , {b}_{j}^{( m )} = {b}_{j}^{*} + \sqrt{{v}_{j}^{*}} {γ}_{j}^{( m )}$$

where ϵⱼ^{(m)} and yⱼ^{(m)} are iid samples from [symbol] (0,1). Note that the approximate p(y|x,S) in (21) depends on our GP prior parameters {θ, β,β_{b}} in a closed form, making the gradient evaluation and stochastic gradient descent training of (10) easy and straightforward. For the meta testing, we also use the same Monte Carlo estimate. The number of samples M=10 usually works well in all our empirical studies. Our approach is dubbed GPLDLA (Gaussian Process Linear Discriminant Laplace Approximation). The final meta training/test algorithms are summarized in Algorithm 1 (see FIG. 8).

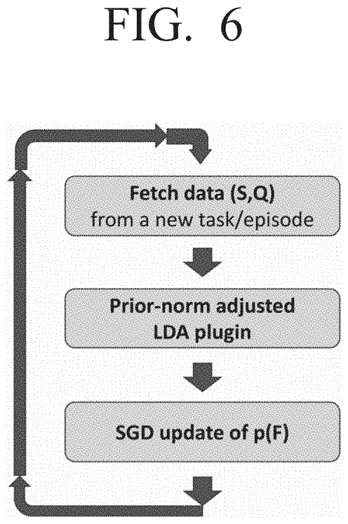

FIG. 6 is a flowchart of example steps for training a machine learning, ML, model using the present techniques. The input is an initial p(F), i.e. randomly initialized meta learner, and the output is a trained p(F), i.e. a trained meta learner. All operations are closed forms, and can therefore be done instantly and/or quickly. In the first step of the flowchart, data are fetched. S is the support dataset and Q is the query dataset. In the second step of the flowchart, the prior-norm adjusted LDA plugin is employed. This second step comprises doing an LDA estimation on S to get p(x,y) and p(y|x), and then matching LDA's p(y|x) and GP's p(y|F(x)) with prior-norm constraints, to get F*≈mode of p(F|S). In the third step of the flowchart, an update of p(F) is performed using the loss=CrossEnt(y∥ŷ=F*(x)) for (x,y)ϵQ. The training method then returns to the start, as shown.

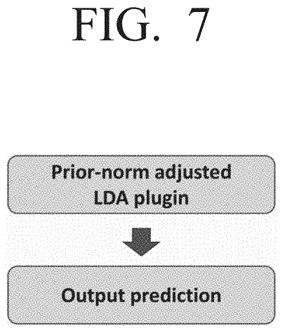

FIG. 7 is a flowchart of example steps to test the ML model. Here, the input to the model is novel task data (S*,Q*), and the trained p(F)— trained meta learner. The output is the class prediction on Q*. The first step of this process is the same as the second step of the flowchart in FIG. 6. The second step of this process is to output a prediction p(ŷ|F*(x)) for xϵ Q*.

Experiments. In this section we test our GPLDLA on several popular benchmark tasks/datasets in meta few-shot classification. We demonstrate the performance improvement over the state-of-the-arts, especially highlighting more accurate prediction than the previous GP few-shot model, GPDKT (Patacchiola et al).

Implementation details. For fair comparison with existing approaches, we use the same feature extractor backbone network architectures ϕ_{θ}(x) (e.g., convolutional networks or ResNets (Kaiming He, Xiangyu Zhang, Shaoqing Ren, and Jian Sun. Deep residual learning for image recognition. CoRR, abs/1512.03385, 2015) as competing models such as ProtoNet (Snell et al), Baseline++(Wei-Yu Chen, Yen-Cheng Liu, Zsolt Kira, Yu-Chiang Wang, and Jia-Bin Huang. A closer look at few-shot classification. In International Conference on Learning Representations, 2019), SimpleShot (Yan Wang, Wei-Lun Chao, Kilian Q. Weinberger, and Laurens van der Maaten. SimpleShot: Revisiting Nearest-Neighbor Classification for Few-Shot Learning. arXiv preprint arXiv: 1911.04623, 2019) and GPDKT (Patacchiola et al). For all experiments we use normalized features

$$( ϕ ( x ) \to \frac{ϕ ( x )}{‖ ϕ ( x ) ‖} ) ,$$

which corresponds to the cosine-similarity outer kernel with the original feature in our deep kernel GP covariance function (8). As the GP prior parameters β,β_{b}, the only extra parameters, are constrained to be positive, we represent them as exponential forms and perform gradient descent in the exponent space. The number of Monte Carlo samples is fixed as M=10 for all experiments.

Datasets/tasks and protocols. We consider both within-domain and cross-domain few-shot learning setups: the former takes the training and test episodes/tasks from the same dataset, while the latter takes training tasks from one dataset and test tasks from another. For the within-domain setup, we use the three most popular datasets, the Caltech-UCSD Birds (denoted by CUB) (P. Welinder, S. Branson, T. Mita, C. Wah, F. Schroff, S. Belongie, and P. Perona. Caltech-UCSD Birds 200. Technical Report CNS-TR-2010-001, California Institute of Technology, 2010), the minilmageNet (Oriol Vinyals, Charles Blundell, Timothy Lillicrap, Koray Kavukcuoglu, and Daan Wierstra. Matching networks for one shot learning. In Advances in Neural Information Processing Systems, 2016), and the tieredlmageNet (Mengye Ren, Eleni Trianta_llou, Sachin Ravi, Jake Snell, Kevin Swersky, Joshua B. Tenenbaum, Hugo Larochelle, and Richard S. Zemel. Meta-Learning for Semi-Supervised Few-Shot Classification. arXiv preprint arXiv: 1803.00676, 2018). The CUB dataset has 11788 images from 200 classes (where the images are of birds and the classes are bird species), the minilmageNet has 60,000 images from 100 classes, while the tieredlmageNet contains 779,165 images from 608 classes. We follow the standard data split: 100/50/50 classes for training/validation/test data for CUB, 64/16/20 for minilmageNet, and 391/97/160 for tieredlmageNet. For the meta few-shot learning formation, we also follow the standard protocol: Each episode/task is formed by taking 5 random classes, and take k=1 or k=5 samples from each class for the support set S in the 1-shot or 5-shot cases. The query set is composed of k_{q}=15 samples per class. We only deal with C=5-way classification. The number of meta training iterations (i.e., the number of episodes) is chosen as 600 for 1-shot and 400 for 5-shot problems. The test performance is measured on 600 random test episodes/tasks averaged over 5 random runs. For the cross-domain setup, we consider two problems: i) OMNIGLOT-EMNIST (that is, trained on the OMNIGLOT dataset (B. M. Lake, R. R. Salakhutdinov, and J. Tenenbaum. Oneshot learning by inverting a compositional causal process, 2013. In Advances in Neural Information Processing Systems) and validated/tested on the EMNIST (Gregory Cohen, Saeed Afshar, Jonathan Tapson, and Andre van Schaik. EMNIST: Extending MNIST to handwritten letters. In International Joint Conference on Neural Networks (IJCNN), 2016) and ii) miniImageNet→CUB. We follow the data splits, protocols, and other training details that are identical to those described in Patacchiola et al.

Within-domain classification. The results on the CUB, miniImageNet, and tieredlmageNet datasets are summarized in Table 1, Table 2, and Table 3, respectively. To have fair comparison with existing approaches, we test our model on the four-layer convolutional network (known as Conv-4) used in Snells et al and Vinyals et al, and ResNet-10 as the backbone networks for the CUB dataset. For the miniImageNet and tieredlmageNet, we use the Conv-4 and ResNet-18. We compare our GPLDLA with several state-of-the-arts, including MAML (Finn et al), ProtoNet (Snell et al), MatchingNet (Vinyals et al), and RelationNet ((Flood Sung, Yongxin Yang, Li Zhang, Tao Xiang, Philip H. S. Torr, and Timothy M. Hospedales. Learning to Compare: Relation Network for Few-Shot Learning. In IEEE/CVF Conference on Computer Vision and Pattern Recognition (CVPR), June 2018). We also consider the simple feature transfer, as well as strong baselines such as Baseline++(Chen et al) and SimpleShot (Wang et al). Among others, the (hierarchical) Bayesian approaches including VERSA (Jonathan Gordon, John Bronskill, Matthias Bauer, Sebastian Nowozin, and Richard Turner. Meta-learning probabilistic inference for prediction. In International Conference on Learning Representations, 2019), LLAMA (Erin Grant, Chelsea Finn, Sergey Levine, Trevor Darrell, and Thomas Griffiths. Recasting Gradient-Based Meta-Learning as Hierarchical Bayes. In International Conference on Learning Representations, 2018) and Meta-Mixture (Ghassen Jerfel, Erin Grant, Thomas L. Griffiths, and Katherine Heller. Reconciling meta-learning and continual learning with online mixtures of tasks. In Advances in Neural Information Processing Systems, 2019), are also compared. However, we exclude methods that use more complex backbones or more sophisticated learning schedules, and those that require a large number of extra parameters to be trained.

TABLE 1
Average accuracies and standard deviations on the
CUB dataset. Best results are shown in bold.

| | Conv-4 | | ResNet-10 | |
|---|---|---|---|---|
| Methods | 1-shot | 5-shot | 1-shot | 5-shot |
| Feature Transfer | 46.19 ± 0.64 | 68.40 ± 0.79 | 63.64 ± 0.91 | 81.27 ± 0.57 |
| Baseline++ | 61.75 ± 0.95 | 78.51 ± 0.59 | 69.55 ± 0.89 | 85.17 ± 0.50 |
| MatchingNet | 60.19 ± 1.02 | 75.11 ± 0.35 | 71.29 ± 0.87 | 83.47 ± 0.58 |
| ProtoNet | 52.52 ± 1.90 | 75.93 ± 0.46 | 73.22 ± 0.92 | 85.01 ± 0.52 |
| MAML | 56.11 ± 0.69 | 74.84 ± 0.62 | 70.32 ± 0.99 | 80.93 ± 0.71 |
| RelationNet | 62.52 ± 0.34 | 78.22 ± 0.07 | 70.47 ± 0.99 | 83.70 ± 0.55 |
| SimpleShot | — | — | 53.78 ± 0.21 | 71.41 ± 0.17 |
| GPDKT^{CosSim} | 63.37 ± 0.19 | 77.73 ± 0.26 | 70.81 ± 0.52 | 83.26 ± 0.50 |
| GPDKT^{BNCosSim} | 62.96 ± 0.62 | 77.76 ± 0.62 | 72.27 ± 0.30 | 85.64 ± 0.29 |
| GPLDLA | 63.40 ± 0.14 | 78.86 ± 0.35 | 71.30 ± 0.16 | 86.38 ± 0.15 |

TABLE 2
Results on the miniImageNet dataset. Best scores are in bold.

| | Conv-4 | | ResNet-18 | |
|---|---|---|---|---|
| Methods | 1-shot | 5-shot | 1-shot | 5-shot |
| Feature Transfer | 39.51 ± 0.23 | 60.51 ± 0.55 | — | — |
| Baseline++ | 47.15 ± 0.49 | 66.18 ± 0.18 | 51.87 ± 0.77 | 75.68 ± 0.63 |
| MatchingNet | 48.25 ± 0.65 | 62.71 ± 0.44 | — | — |
| ProtoNet | 44.19 ± 1.30 | 64.07 ± 0.65 | 54.16 ± 0.82 | 73.68 ± 0.65 |
| MAML | 45.39 ± 0.49 | 61.58 ± 0.53 | — | — |
| RelationNet | 48.76 ± 0.17 | 64.20 ± 0.28 | 52.48 ± 0.86 | 69.83 ± 0.68 |
| ML-LSTM | 43.44 ± 0.77 | 60.60 ± 0.71 | — | — |
| SNAIL | 45.10 | 55.20 | — | — |
| VERSA | 48.53 ± 1.84 | 67.37 ± 0.86 | — | — |
| LLAMA | 49.40 ± 1.83 | — | — | — |
| Meta-Mixture | 49.60 ± 1.50 | 64.60 ± 0.92 | — | — |
| SimpleShot | 49.69 ± 0.19 | 66.92 ± 0.17 | 62.85 ± 0.20 | 80.02 ± 0.14 |
| GPDKT^{CosSim} | 48.64 ± 0.45 | 62.85 ± 0.37 | — | — |
| GPDKT^{BNCosSim} | 49.73 ± 0.07 | 64.00 ± 0.09 | — | — |
| GPLDLA | 52.58 ± 0.19 | 69.59 ± 0.16 | 60.05 ± 0.20 | 79.22 ± 0.15 |

TABLE 3
Results on the tieredImageNet dataset. Best scores are in bold.

| | Conv-4 | | ResNet-18 | |
|---|---|---|---|---|
| Methods | 1-shot | 5-shot | 1-shot | 5-shot |
| ProtoNet | 53.31 ± 0.89 | 72.69 ± 0.74 | — | — |
| MAML | 51.67 ± 1.81 | 70.30 ± 1.75 | — | — |
| RelationNet | 54.48 ± 0.48 | 71.31 ± 0.78 | — | — |
| SimpleShot | 51.02 ± 0.20 | 68.98 ± 0.18 | 69.09 ± 0.22 | 84.58 ± 0.16 |
| GPLDLA | 54.75 ± 0.24 | 72.93 ± 0.26 | 69.45 ± 0.37 | 85.16 ± 0.19 |

Our approach achieves the best performance on most of the setups. On the CUB dataset, GPLDLA attains the highest accuracies for three cases out of four. On the miniImageNet, GPLDLA exhibits significantly higher performance than competing methods when the simpler backbone (Conv-4) is used, while being the second best and comparable to SimpleShot with the ResNet18 backbone (SimpleShot with ResNet-18 backbone on the CUB scored accuracy 64.46 (1-shot) and 81.56 (5-shot)). And our GPLDLA outperforms GPDKT with all different kernels in most of the cases. GPLDLA also performs the best on tieredlmageNet.

Cross-domain classification. Unlike within-domain classification, we test the trained model on test data from a different domain/dataset. This cross-domain experiments can judge the generalization performance of the few-shot algorithms in challenging unseen domain scenarios. The results are summarized in Table 4 where we use the Conv-4 backbone for both cases. GPLDLA exhibits the best performance for most cases outperforming GPDKT, except for one case. Our GPLDLA also performs comparably well with recent approaches with the ResNet-18 backbone on the miniImageNetCUB task as shown in Table 5.

TABLE 4
Cross-domain classification performance. Best scores are in bold.

| | OMNIGLOT→EMNIST | | miniImageNet→CUB | |
|---|---|---|---|---|
| Methods | 1-shot | 5-shot | 1-shot | 5-shot |
| Feature Transfer | 64.22 ± 1.24 | 86.10 ± 0.84 | 32.77 ± 0.35 | 50.34 ± 0.27 |
| Baseline++ | 56.84 ± 0.91 | 80.01 ± 0.92 | 39.19 ± 0.12 | 57.31 ± 0.11 |
| MatchingNet | 75.01 ± 2.09 | 87.41 ± 1.79 | 36.98 ± 0.06 | 50.72 ± 0.36 |
| ProtoNet | 72.04 ± 0.82 | 87.22 ± 1.01 | 33.27 ± 1.09 | 52.16 ± 0.17 |
| MAML | 72.68 ± 1.85 | 83.54 ± 1.79 | 34.01 ± 1.25 | 48.83 ± 0.62 |
| RelationNet | 75.62 ± 1.00 | 87.84 ± 0.27 | 37.13 ± 0.20 | 51.76 ± 1.48 |
| GPDKT^{Linear} | 75.97 ± 0.70 | 89.51 ± 0.44 | 38.72 ± 0.42 | 54.20 ± 0.37 |
| GPDKT^{CosSim} | 73.06 ± 2.36 | 88.10 ± 0.78 | 40.22 ± 0.54 | 55.65 ± 0.05 |
| GPDKT^{BNCosSim} | 75.40 ± 1.10 | 90.30 ± 0.49 | 40.14 ± 0.18 | 56.40 ± 1.34 |
| GPLDLA | 76.65 ± 0.29 | 89.71 ± 0.14 | 41.92 ± 0.27 | 60.88 ± 0.30 |

TABLE 5
Cross-domain classification performance with ResNet-18
backbone on miniImageNet→CUB. Best scores are in bold.

| Methods | 1-shot | 5-shot |
|---|---|---|
| Assoc-Align | 47.25 ± 0.76 | 72.37 ± 0.89 |
| Neg-Margin | — | 69.30 ± 0.73 |
| Cross-Domain | 47.47 ± 0.75 | 66.98 ± 0.68 |
| GPLDLA | 48.94 ± 0.45 | 69.83 ± 0.36 |

Calibration errors. Considering the practical use of the machine learning algorithms, it is important to align the model's prediction accuracy and its prediction confidence. For instance, when model's prediction is wrong, it would be problematic if the confidence of prediction is high. In this section we evaluate this alignment measure for our approach. Specifically we employ the expected calibration error (ECE) as the measure of misalignment. The ECE can be computed by the following procedure: the model's prediction confidence scores on the test cases are sorted and partitioned into H bins (e.g., H=20), and for each bin we compute the difference between prediction accuracy (on the test examples that belong to the bin) and the confidence score of the bin. The ECE is the weighted average of these differences over the bins with the weights proportional to the numbers of bin samples. Hence the smaller the better.

Following Patacchiola et al, we sample 3000 tasks from the test set on the CUB dataset, and calibrate the temperature parameter by minimizing the negative log-likelihood score, and use another 3000 tasks from the test data to evaluate the ECE loss. The ECE losses averaged over five random runs are summarized in Table 6. On the 1-shot case, our GPLDLA attains the lowest calibration error, while being slightly worse than ProtoNet and GPDKT on 5-shot.

TABLE 6
Expected calibration errors. Best scores are in bold.

| Methods | 1-shot | 5-shot |
|---|---|---|
| Feature Transfer | 12.57 ± 0.23 | 18.43 ± 0.16 |
| Baseline++ | 4.91 ± 0.81 | 2.04 ± 0.67 |
| MatchingNet | 3.11 ± 0.39 | 2.23 ± 0.25 |
| ProtoNet | 1.07 ± 0.15 | 0.93 ± 0.16 |
| MAML | 1.14 ± 0.22 | 2.47 ± 0.07 |
| RelationNet | 4.13 ± 1.72 | 2.80 ± 0.63 |
| GPDKT^{BNCosSim} | 2.62 ± 0.19 | 1.15 ± 0.21 |
| GPLDLA | 0.74 ± 0.12 | 1.34 ± 0.16 |

We proposed a novel GP meta learning algorithm for few-shot classification. We adopt the Laplace posterior approximation but circumvent iterative gradient steps for finding the MAP solution by our novel LDA plugin with prior-norm adjustment. This enables closed-form differentiable GP posteriors and predictive distributions, thus allowing fast meta training. We empirically verified that our approach attained considerable improvement over previous approaches in both standard benchmark datasets and cross-domain adaptation scenarios.

Those skilled in the art will appreciate that while the foregoing has described what is considered to be the best mode and where appropriate other modes of performing present techniques, the present techniques should not be limited to the specific configurations and methods disclosed in this description of the preferred embodiment. Those skilled in the art will recognise that present techniques have a broad range of applications, and that the embodiments may take a wide range of modifications without departing from any inventive concept as defined in the appended claims.

What is claimed is:

1. A computer-implemented method of training a machine learning, ML, meta learner classifier model to perform few-shot image or speech classification, the method comprising:
training the machine learning, ML, meta learner classifier model by:
iteratively obtaining a support set and a query set of a current episode,
adapting the model using the support set,
measuring a performance of the adapted model using the query set, and
updating the classifier based on the performance,
wherein adapting the model using the support set comprises:
deriving a Laplace approximated posterior using a linear classifier based on Gaussian mixture fitting, and
deriving a predictive distribution using the approximated posterior,
wherein measuring the performance of the adapted model using the query set comprises:
determining a loss associated with the predictive distribution using the query set, and
wherein updating the classifier based on the performance comprises minimising the loss.

2. The method as claimed in claim 1 wherein deriving a Laplace approximated posterior comprises using a linear classifier based on Gaussian mixture fitting.

3. An apparatus for training a machine learning, ML, model to perform few-shot image classification, the apparatus comprising:
at least one processor coupled to memory, and arranged to:
obtain support dataset and query dataset, and
train a meta learner using the support dataset to output a classifier by:
deriving a Laplace approximated posterior using the support dataset,
deriving, using the posterior, a predictive distribution, and
determining a loss associated with the predictive distribution using the query dataset, and training the meta learner to minimise the loss.

4. A computer-implemented method of performing few-shot image or speech classification, the method comprising:
obtaining a support set and a query set of an episode; and
predicting a class of the query set using the machine learning, ML, meta learner classifier model trained according to the method of any preceding claim.

5. An apparatus for using a trained ML model to perform few-shot image classification, the apparatus comprising:
at least one processor coupled to memory, arranged to:
obtain task data, wherein the task data comprises a support dataset and query dataset,
input the task data into a trained meta learner, and
output, from the trained meta learner, a class prediction for the query dataset.
